(19) United States
(12) Patent Application Publication
(10) Pub. No.: US 2026/0095544 A1
(43) Pub. Date: Apr. 2, 2026

(54) VIDEO CAPTURE INPUT SWITCHING

(71) Applicant: Lenovo (United States) Inc., Morrisville, NC (US)

(72) Inventors: Wenyu Du, Beijing (CN); Jung Hwan Hong, Cary, NC (US); Rod D. Waltermann, Rougemont, NC (US)

(21) Appl. No.: 18/902,723

(22) Filed: Sep. 30, 2024

(51) Int. Cl. H04N 7/14; G06F 3/01; G06V 40/16; H04N 7/15

(52) U.S. Cl. CPC H04N 7/147; G06F 3/012; G06F 3/013; G06V 40/172; H04N 7/15

(57) ABSTRACT

One embodiment provides a method, the method including: identifying, using an image capture switching system, a user is utilizing a first display including an associated first image capture device and a second display including an associated second image capture device and identifying that the first image capture device is capturing video of the user; detecting, using an image capture switching system, that a point of focus of the user has moved from the first display to the second display; and switching, based upon the detecting, a video capture input from the first image capture device associated with the first display to the second image capture device associated with the second display. Other aspects are claimed and described.

### BACKGROUND

Multiple display configurations are becoming increasingly utilized by users. Having multiple displays allows the user to view more information at a single time. Additionally, the user can keep multiple instances of a single application open, instances of multiple applications open, a combination thereof, and/or the like. Thus, instead of needing to minimize and maximize different windows to find the information that a user needs, the user can keep the windows open, all occupying a portion of the multiple displays. This allows a user to be more efficient and effective at performing a desired function or task.

### BRIEF SUMMARY

In summary, one aspect provides a method, the method including: identifying, using an image capture switching system, a user is utilizing a first display having an associated first image capture device and a second display having an associated second image capture device and identifying that the first image capture device is capturing video of the user; detecting, using an image capture switching system, that a point of focus of the user has moved from the first display to the second display; and switching, based upon the detecting, a video capture input from the first image capture device associated with the first display to the second image capture device associated with the second display.

Another aspect provides a system, the system including: a first display having an associated first image capture device; a second display having an associated second image capture device; a processor; a memory device that stores instructions that, when executed by the processor, causes the system to: identify, using an image capture switching system, a user is utilizing the first display having an associated first image capture device and a second display having an associated second image capture device and identifying that the first image capture device is capturing video of the user; detect, using an image capture switching system, that a point of focus of the user has moved from the first display to the second display; and switch, based upon the detecting, a video capture input from the first image capture device associated with the first display to the second image capture device associated with the second display.

A further aspect provides a product, the product including: a computer-readable storage device that stores executable code that, when executed by a processor, causes the product to: identify, using an image capture switching system, a user is utilizing a first display having an associated first image capture device and a second display having an associated second image capture device and identifying that the first image capture device is capturing video of the user; detect, using an image capture switching system, that a point of focus of the user has moved from the first display to the second display; and switch, based upon the detecting, a video capture input from the first image capture device associated with the first display to the second image capture device associated with the second display.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for switching a video capture input from a first image capture device to a second image capture device based upon a detection of a change of focus of the user from a first display to a second display.

### DETAILED DESCRIPTION

While utilizing multiple monitors is useful for displaying multiple windows and/or multiple data simultaneously, to utilize the information displayed across the multiple displays, a point of focus of the user has to move from one display to the other display when the desired information is being displayed on disparate displays. This is generally fine, but when a user is utilizing software that captures video of the user and transmits to the video to another location, the change in focus of the user can be problematic. With the use of an image capture device, when the user is not looking directly at the image capture device or at least in the direction of the image capture device, the resulting video of the user shows the user looking in a different location. In the case that the video is being transmitted to other users, the frequent head movements and lack of direct eye contact can be distracting to the other users. Additionally, it can detract from the overall effectiveness of the communication.

In other words, even if the user is looking at something that is related to the discussion, for example, other participants who are speaking, a presentation related to the discussion, materials related to the discussion, and/or the like, it appears to other participants that the user is not focused on the discussion and is distracted by other things. This is not only true in video conferences, but is also true for other videos of the user. For example, if the user is creating a video explaining how something works and then shares the video on an Internet site, if the user is looking in a direction that is different than the direction of the image capture device, the video may end up looking unprofessional. Thus, it is beneficial to communications and other videos if the user is able to continue to look at least in the same direction as the image capture device that is capturing the video of the user. The problem with this is that it means that the user may not be able to fully utilize the multiple display configuration the user may have.

For example, one solution to the issue of the user looking away from the direction of the image capture device is for the user to put all information that may be needed by the user during the video capture on a single display that is associated with the image capture device capturing the video. However, this reduces the user to utilizing a single display, which negates the benefits of having the multiple display configuration. Additionally, the user may have to prioritize which windows are active due to the reduced display footprint. This may mean that while the user may not change focus to a different display as often, the user will still need to change focus to a different display when information that the user has prioritized lower is needed.

In many multiple display configurations, the displays may each have an associated image capture device, for example, a camera on the display, a camera of the device housing the display, and/or the like. Some video conferencing applications may allow the user to add each of the image capture devices into the video conference. Then, when the user switches focus, the user can provide manual input to change the image capture device that is providing a video feed to the video conferencing software. One issue with this is that other applications do not provide the same functionality. Additionally, in order to use this functionality, the user has to manually change the image capture device input, which disrupts the flow of the presentation of discussion, thereby resulting in a less engaging experience.

Accordingly, the described system and method provides a technique for switching a video capture input from a first image capture device to a second image capture device based upon a detection of a change of focus of the user from a first display to a second display. The image capture switching system identifies that a user is utilizing a first display having an associated first image capture device and is also utilizing a second display having an associated second image capture device. In other words, the system identifies that the user has a multiple display configuration and that each of the displays has an associated image capture device. It should be noted that the image capture device of one or all of the displays does not have to be located on or co-located with the corresponding display. Rather, the image capture device simply has to be somehow associated with the display, which could include being located on the same device as the display, being located in the same line of sight as the display, be located on the display, being accessible by the display, and/or the like.

In addition to identifying that the user is using a first display and a second display, the system identifies that the first image capture device is capturing video of the user. This may include video that is being captured and transmitted, in real-time, to a third-party, for example, a participant in a video conference. Upon detecting that a point of focus of the user has moved from the first display to the second display, the system switches the video capture input from the first image capture device to the second image capture device. In other words, when the system detects that the user is no longer looking at the first display and is now looking at the second display, the system switches the image capture device from the image capture device associated with the first display to the image capture device associated with the second display. Thus, from a viewing perspective it appears that the user is still looking in the direction of the image capture device that is providing the video, because the user is doing exactly that.

Therefore, a system provides a technical improvement over traditional methods for switching a video capture input from one image capture device to another. Rather than traditional methods that rely on the user to manually switch the image capture device, the described system and embodiment is able to automatically switch the video capture input from one image capture device to another. This prevents the break in focus and the discussion that is caused by the user having to manually switch the device. Additionally, since the system can automatically switch the input device, the user does not have to worry about frequently switching a point of focus from one display to another, because the system is able to detect this point of focus movement and switch the video capture input. Finally, since the system will switch the input device, the user does not have to configure their virtual workspace to reduce the amount of information that is displayed across multiple displays, thereby allowing the user to utilize the multiple display configuration to the fullest extent even during the capture of video. Accordingly, the described system and method provides a technique for switching a video input device that is less obtrusive, more efficient and responsive, and that provides a better video capture and video viewing experience than traditional system and methods.

The illustrated example embodiments will be best understood by reference to the figures. The following description is intended only by way of example, and simply illustrates certain example embodiments.

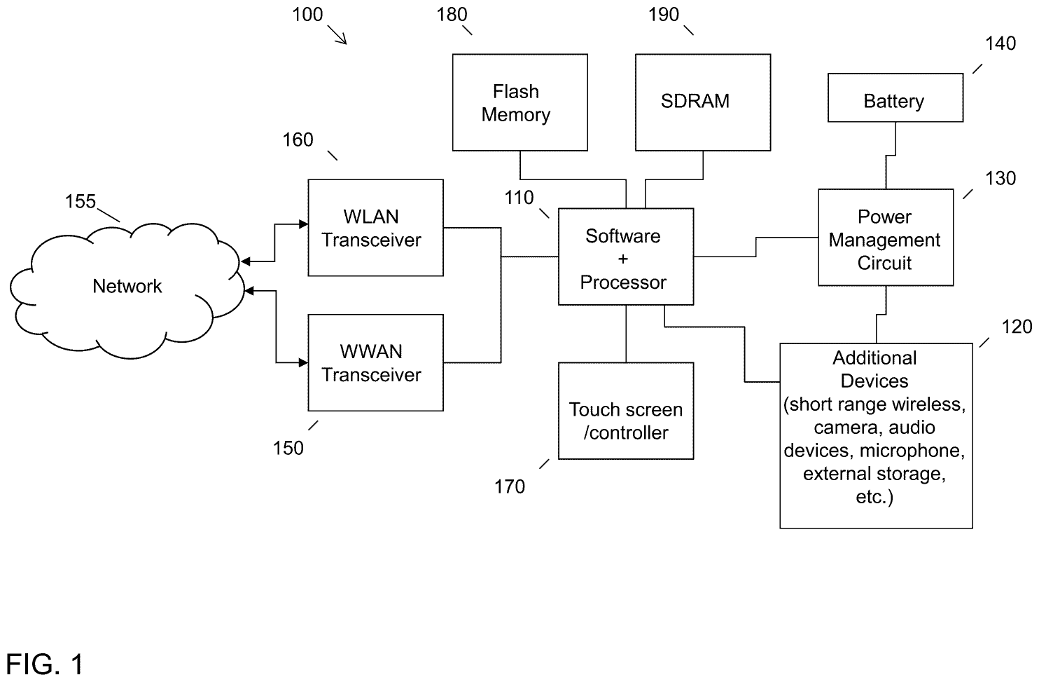

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

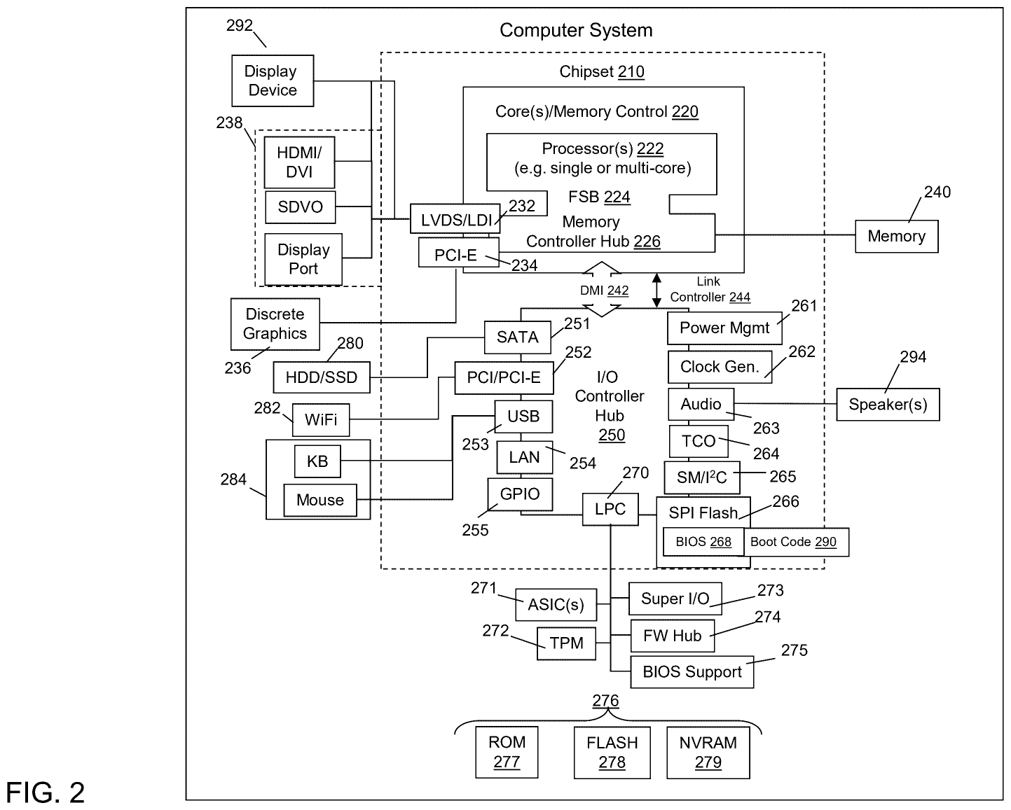

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include or be associated with image capture devices that can be used by users to capture video of the user. For example, the circuitry outlined in FIG. 1 may be implemented in a tablet or smart phone embodiment, whereas the circuitry outlined in FIG. 2 may be implemented in a personal computer embodiment.

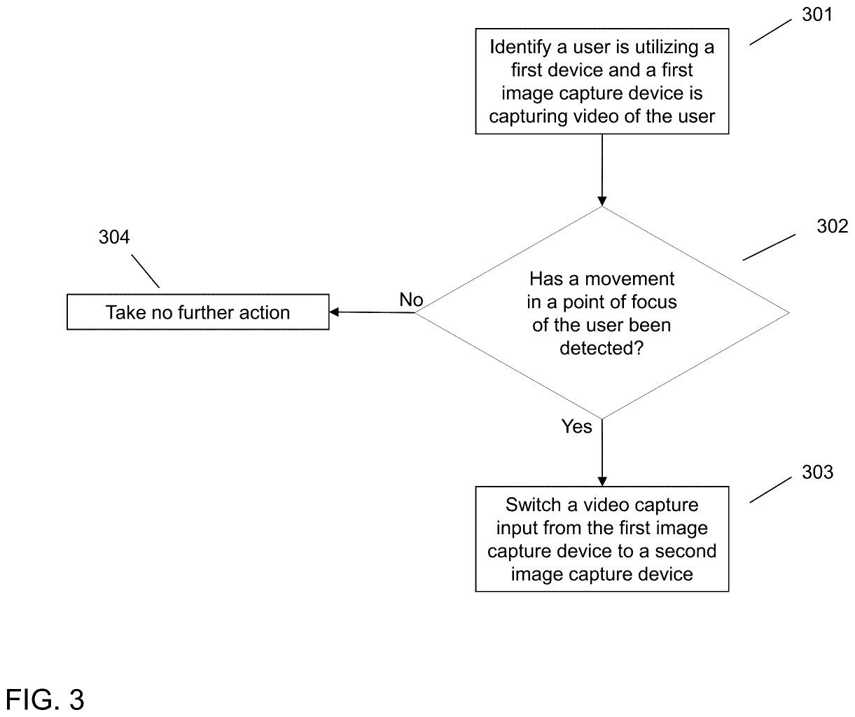

FIG. 3 illustrates an example method for switching a video capture input from a first image capture device to a second image capture device based upon a detection of a change of focus of the user from a first display to a second display. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to switch from one image capture device to another based upon a detection in a change of focus of the user. Additionally, the image capture switching system includes modules and features that are unique to the described system.

Activation of the image capture switching system may be a manual activation of the image capture switching system and/or an automatic activation of the image capture switching system. The automatic activation of the image capture switching system may be based upon the detection of a trigger event indicating that the system should be activated.

The image capture switching system may be made of multiple systems or modules that communicate together to make up the image capture switching system or may be a single system. The image capture switching system may be a standalone system, may be accessible through other computing devices, and/or a combination thereof. For example, the image capture switching system may be a standalone system that can be accessed by a user and/or may be or provide an application that is accessible by a user on another computing device. The image capture switching system may be accessible using any type of computing device, for example, personal computer, laptop computer, smartphone, tablet, smartwatch, head-mounted display, smart television or other smart appliance, augmented reality device, virtual reality device, and/or the like.

Thus, the image capture switching system may be accessible locally using a computing device where the image capture switching system is installed and/or may be accessible remotely through another computing device. For example, the image capture switching system may be accessed by a user using a device that communicates with the image capture switching system. However, the image capture switching system may be located and operate on a different information handling device as compared to the device being utilized by the user to perform the described steps.

The image capture switching system may have an associated graphical user interface. The graphical user interface may be provided on a display or monitor, which may or may not be associated with the image capture switching system. In other words, the image capture switching system may have a dedicated display or monitor or may be accessible using any display or monitor. In either case, the image capture switching system may provide instructions to generate and display the graphical user interface on the display device being used to access the image capture switching system. The graphical user interface may also be updated and managed based upon instructions provided by the image capture switching system. In other words, the image capture switching system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the image capture switching system. For example, the image capture switching system may utilize a user profile, device profile, and/or the like, to identify user preferences, how the switching of image capture devices should be performed, accessible image capture devices, which image capture devices are associated with particular displays, and/or the like. The graphical user interface may allow for creation of or access to these profiles, historical information, or other information, and/or the like, by allowing a user to input information regarding user preferences, device information, and/or the like. As will be discussed in more detail, the use of user provided information is not the only way that the profile and/or historical information can be created. The image capture switching system can then utilize these inputs to create the profile(s), identify what image capture devices can be switched, with which what displays are associated with what image capture devices, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, information of image capture devices or displays, and/or the like. It should be noted that the information to be used by the image capture switching system and information provided by the image capture switching system can be different for different applications, different computing systems, different users, and/or the like. Thus, the information corresponding to input or output of the image capture switching system are not always the same. However, the image capture switching system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The image capture switching system may utilize one or more artificial intelligence models in switching a video capture input. Artificial intelligence models could be designed to detect that a point of focus has been moved, determine which a video capture input should be switched, or any other steps within the described system. Artificial intelligence models may also be used for steps within a step. For example, a model could be utilized to analyze images to determine when a point of focus of a user has moved, perform facial recognition to determine when a point of focus of a user has moved, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the image capture switching system or may be a model that is created from scratch. Since the image capture switching system is used in conjunction with detecting a point of focus movement and switching a video capture input, some models that may be utilized by the system are image analysis models, audio analysis models, other analysis models, object identification models, entity identification models, similarity identification models, language models, large language models, filtering models, classification models, and/or the like. The model may be trained using one or more training datasets.

Additionally, as the model is deployed, it may receive feedback to become more accurate over time. The feedback may be automatically ingested by the model as it is deployed, may be stored for subsequent training, may be stored in a data storage location to be accessed by the model for subsequent predictions, and/or the like. For example, as the model is used to perform the described method, if a user modifies predictions that were made by the model, provides feedback regarding a prediction, or otherwise provides some indication that the predictions or selections made by the model may be incorrect, the feedback can be utilized to better train the model, be placed into a data storage location accessible and usable by the model, or otherwise used to improve the accuracy of the model.

On the other hand, as the model makes predictions in connection with performing the described steps, and no changes are made to the resulting prediction, the model system may also utilize this as feedback to make the model better. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The image capture switching system may include different components for carrying out different functions of the system, including different steps to be performed. These components may be hardware components or software components. Some hardware devices or components that may be utilized by the image capture switching system include input devices that may be utilized to receive input from the user, for example, mechanical input modalities (e.g., keyboard, mouse, etc.), touch input devices, gesture input devices, electromyography input devices, audio input devices, image capture devices, and/or the like. Other hardware components may be utilized to provide output from the image capture switching system. For example, the image capture switching system may include speakers, displays or monitors, haptic output devices, audio output devices, and/or the like. Other hardware components may be included.

One software component includes the user profile that stores information related to the user and user preferences. The user profile may be unique to a user and may assist in determining when a video capture input should be switched, how to detect a point of focus has moved, and/or the like. The user profile may include user preferences. For example, the user profile may identify how long the point of focus of the user has to be no longer on the first display before the video capture input is switched, what image capture devices should be utilized for different displays or devices, how to treat the background within the video captured by the image capture device, and/or the like. The user profile may also include other information about the user that seems to influence video capture input switching and/or point of focus movement detection, for example, a device that the user is using during different sessions, a location where the user is located when video capture inputs are switched, different applications that allow for video capture input switching, and/or the like.

The user may manually input data into the profile or the information within the profile may be populated by the system as the system learns about the user over time. For example, the system may utilize an artificial intelligence model to learn about the user, make correlations between information received about the user and the switching of a video capture input, and/or the like. This information can be populated within the user profile for use by the system during subsequent video capture sessions.

At 301, the image capture switching system identifies that a user is utilizing a first display having an associated first image capture device and a second display having an associated second image capture device and identifying that the first image capture device is capturing video of the user. In other words, the system determines that the user is utilizing a multiple display configuration where at least some of the displays have associated image capture devices. Additionally, the system identifies that the first image capture device is capturing video of the user. It should be noted that the terms “first” and “second” only designate a difference between two of the same types of displays, devices, and/or image capture devices. These terms do not designate a priority, an ordering, or any other numerical information of the displays, devices, and/or image capture devices. The terms do, however, designate a grouping. For example, the first image capture device is associated with the first display or first device. As another example, the second image capture device is associated with the second display or second device. Thus, the terms should be understood accordingly.

Each of the displays has an associated image capture device. However, it should be noted that this does not mean that the image capture device is directly connected to a corresponding display. Rather, an associated image capture device means that the display has an image capture device that is in the line of sight of the user when looking at the display. In other words, when the user is looking at a particular display, the image capture device associated with that display is able to capture a view of the face of the user. Thus, the associated image capture device may be integral to the display, attached to the display, integral to a device housing the display, located behind a display and facing the user when the user is looking at the display, and/or the like. For example, the image capture device of a display may be a camera that is located on a top surface of the display, but that is not integral to the display. As another example, the image capture device of a display may be a camera that is located on a wall behind the display and facing the user when the user is looking at the display. As a final, non-limiting example, the image capture device of a display may be a camera that is integrated into a laptop to which the display is integrated.

The image capture device and display may not directly communicate with each other. Instead, the image capture device and display need only to be located so that when the user is facing or looking at the display, the image capture device is able to capture the face or eyes of the user. In other words, the image capture device needs to be located with respect to the display such that when the user is facing or looking at the display, so that the video of the user captured by the image capture device looks like the user is at least facing the direction of the image capture device, if not looking directly into the image capture device. However, there is no requirement that the display and image capture device communicate with each other, either directly or indirectly. However, the display and image capture device could communicate with each other, either directly or indirectly.

The image capture switching system also identifies that the first image capture device is capturing video of the user. The first image capture device could be capturing video of the user as part of an application where the video of the user is transmitted through the application to a third-party. For example, the user may be accessing a video conferencing application and the video of the user may be transmitted to other participants of the video conferencing application. Thus, the capturing of the video may be responsive to activation of this video conferencing application. As another example, the user may be capturing video to be uploaded to an Internet site, uploaded to a data storage location, and/or the like. The captured video is then accessible to other people at a later time, for example, upon access to the Internet site, data storage location, and/or the like. As a final, non-limiting example, the captured video may be uploaded in real-time to an Internet site, data storage location, and/or the like, that is accessed by other users and also stored for later access by the same or other users. In other words, the transmission of the video being captured by the first image capture device to another individual or group of users may be in real-time or may be at a later time when the individual or group of users accesses the stored video.

At 302, the image capture switching system may determine if movement in a point of focus of the user has been detected. In other words, the system determines whether a point of focus of the user has been moved from the first display to the second display. It should be noted that while two displays are discussed herein, a multiple display configuration can have more than two displays and this system could work with any number of displays.

To detect the point of focus, the image capture switching system may utilize gaze tracking. Gaze tracking allows the system to determine a location of the gaze of the user. The system can then correlate the location of the gaze of the user with an object, for example, a display, a device, and/or the like. Thus, the system can determine which object the user is looking at. Gaze tracking can be very granular, meaning it could be utilized to detect a group of pixels of where the user is looking. However, in this case less granular gaze tracking can be utilized since the system only needs to know which display or device the user is looking at. However, gaze tracking with more accurate resolution can also be utilized in this system. When the system detects that the gaze of the user has moved from one object to a different object (e.g., from one display to another display, from one device to another device, etc.), the system can identify that the point of focus of the user has moved.

Another technique for detecting the point of focus is to utilize facial recognition. Utilizing facial recognition allows the system to identify if a face can be recognized. While facial recognition can do more than just simply identifying whether a face exists or not, such analysis is not strictly necessary, but could be used, in this system. The facial recognition can be utilized to determine if a whole face exists. In other words, the facial recognition can be utilized to determine if the user is facing the image capture device and, if so, the whole face of the user could be detected with the facial recognition. When the user moves their head to look at a different display or device, the facial recognition would recognize that the entirety of the face is not detectable within the image frame. In other words, when the user moves their head, the amount of the face that was detectable before is no longer the same amount of the face that is detectable. Thus, upon identifying a change in a position of the face of the user with the facial recognition, the system could detect movement of the head of the user and, therefore, determine that the point of focus of the user has moved.

Detecting the point of focus of the user could also be performed utilizing sensors that may be located on the user. For example, the user could don a headset, glasses, hat, and/or the like, that may have sensors that can detect motion of the head of the user. These sensors may include accelerometers, gyroscopes, motion sensors, and/or the like. The sensors inputs may be compared to threshold values to determine that the head of the user has moved enough to indicate that the point of focus of the user has moved from a first display to a second display. Additionally, if the user has image capture sensors located on their person, the image capture sensors of the user could be utilized to detect a line of sight of the user based upon detecting a line of sight of the image capture sensor. Thus, based upon the line of sight of the image capture sensors, the system can determine what the user is looking at and whether the point of focus of the user has moved from the first display to the second display.

Detecting the point of focus may also be performed based upon inputs provided by the user. These inputs may be detected on a device that is associated with one of the displays. For example, when the user changes focus from one display to another display, the user may also provide input to a keyboard of the device corresponding to the display, may provide input to a mouse of the device corresponding to the display, may provide input to the display itself, may move the cursor or other input indicator to be located on a screen of the display, and/or the like. In this case, the input does not have to be input where the user manually changes the active image capture device. Instead, this input could be any input that the user might provide at a device, for example, selecting an application, typing in an application, selecting an icon, touching a key on a keyboard, moving a mouse, and/or the like. If input is detected at a device corresponding to the second display, the system may determine that the point of focus of the user has switched from the first display to the second display.

It should be noted that the above-described techniques for detecting that a point of focus of the user has moved are merely illustrative and other techniques for detecting that a point of focus of the user has moved are contemplated and possible. Additionally, the image capture switching system could employ a combination of detection techniques.

If, movement in a point of focus of the user has not been detected at 302, the system may take no further action at 304. In other words, the image capture switching system will continue to capture video of the user with the first image capture device. It should be noted that the number of image capture devices may not match the number of displays. In this case, if the point of focus of the user moves to a display that does not have an associated image capture device, the system may determine if there is an image capture device that is closer to the display of focus than the one currently being utilized to capture the video. If so, the system may switch to that closer image capture device. If not, the system may take no action and leave the current image capture device as the active image capture device, or the image capture device that is capturing the video for transmission, which may be real-time transmission, the storage transmission, and/or the like, or a combination thereof. Additionally, if the point of focus movement does not meet any threshold settings or other identified characteristics, as discussed further herein, the system may take no further action at 304.

If, on the other hand, movement in a point of focus of the user has been detected at 302, the system may switch a video capture input from the first image capture device to the second image capture device associated with the second display at 303. In other words, the image capture switching system will change the image capture device that is used to capture video of the user for the transmission, which may be real-time transmission, the storage transmission, and/or the like, or a combination thereof. The switching of the video capture input is in real-time as video is being captured of the user. In other words, in one frame of a video feed, the video is being supplied by the first image capture device and in the next frame of the video feed, the video is being supplied by the second image capture device.

In switching the video capture input, the image capture switching system may first activate the second image capture device so that the second image capture device captures video of the user. Alternatively, the second image capture device could already be activated capturing video of the user. In this case, even though the second image capture device is activated, the video is being ignored with respect to the video feed being used for transmission. Once the second image capture device is activated, or if it is already activated, the system may push the video being captured by the second image capture device as the video output (the video being used for transmission) in real-time. In other words, the video output is no longer getting video from the first image capture device, but is instead now getting video from the second image capture device. From the perspective of the viewer, this transition is seamless.

Additionally, in order to make the switching less noticeable, the image capture switching system may take into account characteristics between the two image capture devices. For example, if the first image capture device is closer to the user than the second image capture device, when the video capture input is switched, the user will appear bigger or smaller depending on the distance between the user and the image capture device. Thus, the system may take these differences into account when performing the video capture input switching. The system may utilize information identified from the image capture devices while the devices are on but not providing the video input to the video feed.

For example, while the second image capture device is on but not providing the video input to the video feed, the system can be analyzing, using an image analysis technique, artificial intelligence model, analysis system, and/or the like, the video input of the first image capture device to ascertain different video characteristics. These different video characteristics can then be utilized to adjust parameters of the second image capture device, for example, an aspect ratio, magnification values, positioning, focus, and/or the like, so that the video input of the second image capture device matches the video input of the first image capture device. Then, when the video capture input is switched, the video inputs match between the image capture devices and a viewer does not notice the switch.

Additionally, in order to make the switching less noticeable, the image capture switching system may take into account a background of the user. When the video capture input is switched from one image capture device to another, the perspective of the image capture devices are different. Thus, while the user may appear to be still looking towards the image capture device, viewers may notice a “jump” in the background of the user. Accordingly, the system may adjust a background of the user. One technique for adjusting the background may be to make the background of the user stationary and then utilize the same background for all the different image capture devices. For example, the system may capture the background of the user at the first image capture device and then overlay that background over the real-world background when the video capture input is changed to a different image capture device. Thus, the system may adjust the background to match the first background of the user when the user was being captured in video from the first image capture device.

Another technique for adjusting the background is to offset the angle, position, and/or other characteristic of the background so that all the backgrounds match. In other words, since most of the same objects will likely be visible in the background for the different image capture devices, the system could modify the position of the objects in the backgrounds for subsequent image capture devices to match the position of the objects as found in the background of the first image capture device. Thus, the background would be a mix of the real-world background and virtual objects. Alternatively, or additionally, the system could virtually or digitally remove all the objects in the background so that a viewer would not notice the movement of the objects between backgrounds of different image capture devices.

Another technique for adjusting the background may be to use an image for the background that is the same for each of the image capture devices. In other words, instead of showing the real-world background of the user, the system may utilize an overlay background of an image, which may be a default image, an image chosen by the user, a solid color, and/or the like. This overlay background may be presented regardless of which image capture device is capturing and providing the video for the transmission. Other techniques for adjusting the background are contemplated and possible and the described techniques are for illustrative purposes only.

So as to prevent many switches of the video capture input in a very small amount of time, meaning the switching of the video capture input occurs when the user is looking at the second display for a very brief time, the image capture switching system may employ predetermined thresholds to identify when the video capture input should be switched. For example, the system may not switch the video capture input until the point of focus is associated with the second display for a predetermined threshold length of time. The predetermined threshold length of time may be a default value, set by the user, and/or the like. Example predetermined threshold lengths of time include, but are not limited to, half a second, a second, two seconds, five seconds, ten seconds, and/or the like. Thus, the switching of the video capture input may be responsive to detecting the point of focus has been at the second display for at least a predetermined threshold length of time. Alternatively, the system may have no predetermined threshold and the switching will occur upon the detection of the movement of the point of focus regardless of how long the point of focus has been moved.

Instead of, or in addition to, predetermined threshold lengths of time, the system may take into account other characteristics to determine if the switching should not occur based upon detection of a movement of the focus of the user. One characteristic may be something contained within the user profile. For example, the user may identify that a certain image capture device should not be activated and therefore, the video capture input should not be switched if that is the image capture device to which the video capture input would be switched. Another characteristic may a characteristic of the image capture device with respect to the transmission. For example, if the transmission can only support video from an image capture device having certain characteristics and the image capture device to which the video capture input would be switched does not meet those characteristics, the video capture input may not be switched. Another characteristic may be a characteristic of the network or system the user is utilizing for the transmission. If the network or system is unable to support the switching, the system may not switch the video capture input. Other characteristics that can be utilized for determining whether the switching should occur are contemplated and possible and the described characteristics are merely illustrative.

As an overall, non-limiting example of the described system and method, the user may be utilizing a device and display configuration having two different displays. One of the displays has an integrated camera, and the other display has an attached camera. The user is participating in a video conference where the user is speaking and viewing information contained on both the displays. Additionally, video of the user is being captured and transmitted to the other participants in the video conference. Initially, the user is looking at information on the display having the integrated camera, Display A. The camera for Display A, Camera 1, is active, capturing video of the user, and the video feed being transmitted to the other video conference participants includes the video captured form Camera 1.

At some point while the user is speaking, the focus of the user moves to information contained on the display having the attached camera, Display B. The system detects this movement and determines that the user has looked at the information on this display for more than 1 second, which is the threshold time set for this example. Accordingly, the system switches the video capture input from Camera 1 to the attached camera of Display B, Camera 2. Now, Camera 2 is active, capturing video of the user, and the video feed being transmitted to the other video conference participants is the video captured from Camera 2. As the user continues to speak, the focus of the user moves back to Display A. After 1 second of looking at the information on Display A, the system switches the video capture input back to Camera 1, thereby transmitting the video of Camera 1 in the video feed of the video conference for the user.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more”unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using an image capture switching system, a user is utilizing a first display having an associated first image capture device and a second display having an associated second image capture device and identifying that the first image capture device is capturing video of the user;
detecting, using an image capture switching system, that a point of focus of the user has moved from the first display to the second display; and
switching, based upon the detecting, a video capture input from the first image capture device associated with the first display to the second image capture device associated with the second display.

2. The method of claim 1, wherein the detecting comprises utilizing gaze tracking.

3. The method of claim 1, wherein the detecting comprises utilizing facial recognition and detecting movement of the head of the user based upon a change in a position of a face of the user.

4. The method of claim 1, wherein the detecting comprises detecting an input provided by the user at a device corresponding to the second display.

5. The method of claim 1, wherein the detecting comprises utilizing sensors located on a head of the user.

6. The method of claim 1, wherein the switching is responsive to a length of time of the detecting exceeding a predetermined threshold length of time.

7. The method of claim 1, wherein the switching occurs in real-time and wherein a video captured from the second image capture device is pushed as a video output in real-time.

8. The method of claim 1, wherein the switching comprises adjusting a background of the user to match a first background of the user associated with the first image capture device.

9. The method of claim 1, wherein the switching comprises activating the second image capture device.

10. The method of claim 1, wherein the capturing of the video is responsive to activation of a video conferencing application.

11. A system, the system comprising:
a first display having an associated first image capture device;
a second display having an associated second image capture device;
a processor;
a memory device that stores instructions that, when executed by the processor, causes the system to:
identify, using an image capture switching system, a user is utilizing the first display having an associated first image capture device and a second display having an associated second image capture device and identifying that the first image capture device is capturing video of the user;
detect, using an image capture switching system, that a point of focus of the user has moved from the first display to the second display; and
switch, based upon the detecting, a video capture input from the first image capture device associated with the first display to the second image capture device associated with the second display.

12. The system of claim 11, wherein the detecting comprises utilizing gaze tracking.

13. The system of claim 11, wherein the detecting comprises utilizing facial recognition and detecting movement of the head of the user based upon a change in a position of a face of the user.

14. The system of claim 11, wherein the detecting comprises detecting an input provided by the user at a device corresponding to the second display.

15. The system of claim 11, wherein the detecting comprises utilizing sensors located on a head of the user.

16. The system of claim 11, wherein the switching is responsive to a length of time of the detecting exceeding a predetermined threshold length of time.

17. The system of claim 11, wherein the switching occurs in real-time and wherein a video captured from the second image capture device is pushed as a video output in real-time.

18. The system of claim 11, wherein the switching comprises adjusting a background of the user to match a first background of the user associated with the first image capture device.

19. The system of claim 11, wherein the capturing of the video is responsive to activation of a video conferencing application.

20. A product, the product comprising:
a computer-readable storage device that stores executable code that, when executed by a processor, causes the product to:
identify, using an image capture switching system, a user is utilizing a first display having an associated first image capture device and a second display having an associated second image capture device and identifying that the first image capture device is capturing video of the user;
detect, using an image capture switching system, that a point of focus of the user has moved from the first display to the second display; and
switch, based upon the detecting, a video capture input from the first image capture device associated with the first display to the second image capture device associated with the second display.
